(19) United States
(12) Patent Application Publication
(10) Pub. No.: US 2021/0125211 A1
(43) Pub. Date: Apr. 29, 2021

(54) PARAMETER-BASED RECONDITIONING INDEX FOR ESTIMATION OF VEHICLE RECONDITIONING COST

(71) Applicant: Carma Automotive Inc., Regina (CA)

(72) Inventors: Sadra Abedinzadeh, Regina, CA (US); Dan Broderick, Regina, CA (US); Bruce Axelson, Regina, CA (US); Cam Boltrell, Regina, CA (US); Philip James Morris, Regina, CA (US)

(21) Appl. No.: 16/661,096

(22) Filed: Oct. 23, 2019

(51) Int. Cl. G06Q 30/02; G06Q 10/00; G06K 9/62

(52) U.S. Cl. CPC G06Q 30/0206; G06Q 30/0283; G06K 9/6223; G06Q 10/20; G06Q 30/0278

(57) ABSTRACT

A method of creating a parameter based reconditioning index for use in the estimation of reconditioning cost of vehicles based upon the historical reconditioning cost of similar vehicles. A modeling software component operates in conjunction with a reconditioning database containing historical reconditioning cost information to generate a mathematical reconditioning cost function corresponding to a parameter value in respect of the reconditioned vehicle for a parameter set—the function correlates historical reconditioning costs with parameter values of the related reconditioned vehicle for cost records having vehicle parameters within their historical parameter sets that correspond to the vehicle parameters within an index parameter set and which will, when applied to current parameter values of a target vehicle, yield an estimated reconditioning cost for the target vehicle. Periodic updates can be applied on receipt of additional historical reconditioning cost information. A database comprising the index for a plurality of parameter sets, and software methods using the database to predict vehicle reconditioning costs is also disclosed.

### FIELD OF THE INVENTION

This invention is in the field of automated business systems for use in the automobile and equipment sales industry, and more specifically provides a system and method for the generation of a software index which can be used to determine the reconditioning costs of vehicles to a defined standard based on historical data without the need for subjective vehicle inspection.

### BACKGROUND

Businesses in many industries have seen their business workflows enhanced over the last number of you spied the increased availability of various software tools to assist in business decision-making and various business processes. This has included various types of software tools available in the automotive industry and particularly for automotive dealerships. Different software tools are available to allow for the automated processing of paperwork, inventory handling and the like.

One of the key business processes involved at automotive dealerships is the trade-in and handling used vehicles. Quite often in a dealership that sells new vehicles, used vehicles are taken in on trade and in other environments, used vehicle specials dealerships may also simply purchase used vehicles from people wishing to sell them. Handling of used vehicle inventory is a narrow margin element of the business requiring high accuracy.

One of the key calculations that needs to be made in the acceptance and processing of used vehicle inventory is estimation of the value of a used car. There are many different types of value guides available, both printed and online, however none of them accurately account for the cost of reconditioning the vehicle in the dealership to whatever the predetermined reconditioning standard is for resale. Reconditioning cost is the cost of the process of repairs—i.e. mechanical, cosmetic repairs, replacement of tires or glass etc.—needed to be made to the vehicle in order to sell it again. The reconditioning difference can be a make or break cost element for dealerships, with typically low gross margins. Traditionally, the estimation of used vehicle value and reconditioning cost would be done manually and subjectively by staff in a dealership who would inspect the vehicle and based on past experience and whatever documentation was prepared at the dealership level be able to come up with a reasonably accurate reconditioning cost and is vehicle value. This is extremely time intensive and takes staff with a large amount of past experience and dealership history to deliver in a reasonable fashion

In some basic software iterations, at the dealership level, tools have been developed which solve the problem of estimating the value of a used car by offering static values. For example each particular type of repair is worth a static amount—a new windshield is $500, new tires are $400, or the like—while this is better than a completely manual process it cannot be used in an environment where the vehicle is not seen and inspected by the dealership since in order for this type of a method to work each type of a statically valued repair needs to be assessed and inventoried by the dealership on view of the vehicle. This method requires extra information i.e. you already need to know what is wrong with the vehicle in order to used car value based on reconditioning cost. Some tools have also been developed which simply allow for the estimation of reconditioning cost based upon the mileage of the vehicle.

If it were possible to come up with a method of estimating reconditioning cost for a vehicle based upon objective versus subjective factors of the vehicle, this could allow for the development of a more objectively deployed method which could be remotely used. For example, intuitively you could estimate reconditioning cost going up with the mileage on the vehicle. A dealership could plot their historical records of reconditioning costs for different types of vehicles against mileage, and create some type of a basic non-machine learning computer program which would allow for the rendering of an estimated reconditioning cost result based upon capture of one or more objective factors of the vehicle. The ability to estimate the reconditioning cost of vehicle using only objectively measured characteristics of the vehicle would allow for the deployment of a web service or remotely operable method for the rendering of computer-assisted reconditioning costs and used vehicle values for various types of vehicles.

If a cloud-based or remotely usable method were available it is believed that this would be widely commercially acceptable in industry.

One of the other benefits of a remotely available service providing electronically facilitated vehicle values using objective versus subjective measurements or estimations of vehicle conditioning would be the fact that a broader dataset could be used. For example the method or software could be made available to customers or dealerships in many different locations or geographic areas and insofar as the method would rely upon a rule-based program containing a data plot with historical reconditioning costs from a broader set of locations or vehicle reconditioning transactions, the accuracy of the method could be further enhanced and the cost of development of the tool could be spread across multiple customers or geographical areas. This is another reason that a cloud-based or remotely deployed service, which would allow for the use of vehicle reconditioning cost calculations based upon simply captured objective measurements of the vehicle, versus the need for an in person subjective inspection, would it is believed to be broadly commercially acceptable.

It is further believed that if a method of providing a remotely usable objectively based reconditioning cost calculation method incorporated a machine learning program that would allow for the highest level of accuracy in reconditioning cost calculations, since nonlinear patterns and historical vehicle reconditioning costs of various transactions could be accommodated in the establishment of a mathematical function which could be used to most accurately estimate reconditioning cost for particular types of vehicles wearing one or more particular objective vehicle parameters were captured.

Overall then it is believed that if it were possible to create a means and method of rendering of a parameter based reconditioning index for estimation of vehicle reconditioning cost, which rely primarily or completely upon objective parameters of particular vehicles being captured and mathematically modelled functions allowing for the most accurate possible estimation of reconditioning cost based on historical transaction costs this would be an extremely desirable commercial result in a heretofore largely non-automated area of the automotive distribution and resale industry.

### SUMMARY OF THE INVENTION

As outlined above the object of the present invention is to provide a computer implemented method of creating a parameter-based reconditioning index for use in the estimation of the reconditioning cost of the ankles and equipment to a defined standard. In a first embodiment of the invention, these objectives are achieved in such a computer implemented method of creating a parameter-based reconditioning index for use in the estimation of the reconditioning cost of target vehicles to a defined standard, based upon the historical reconditioning cost of similar vehicles. The method is executed comprising a first step or using equipment comprising a server with a processor and memory, and a modeling software component capable of carrying out the steps in the method in conjunction with a reconditioning database.

The reconditioning database comprises a plurality of parameter records, each of which corresponds to a particular type of vehicle parameter in respect of which a value can be captured in respect to the target vehicle. Each parameter record will contain details of permissible parameter values. As will be understood from the content of this document and the scope outlined elsewhere herein, any type of the vehicle parameter capable of being captured is of value is contemplated within the scope of the present invention including something as simple as vehicle make, age, model, mileage or the like, through to other more granular parameters.

In addition to the plurality parameter records, the reconditioning database would also comprise a plurality of cost records. Each cost record corresponds to a historical reconditioning transaction of a reconditioned vehicle and contains the necessary information to be used in the remainder of the method to incorporate historical reconditioning costs of the particular type of vehicle into the mathematical functions generated and used in the reconditioning index. Each cost record would contain a parameter value in respect of the can reconditioned vehicle for a historical parameter set comprising at least one vehicle parameter corresponding to a parameter record in the reconditioning database. Many cost records might include parameter values for multiple parameters corresponding to multiple parameter records and will be understood to be within the scope of the present invention as well. In addition to the parameter values in respect of the rate reconditioned vehicle the subject of the historical reconditioning transaction, the cost record would also include the historical reconditioning costs associated with that transaction.

The reconditioning database would also comprise a plurality of index records. Each index record corresponds to a parameter-based index which can be used to generate historically informed reconditioning costs for target vehicles. Each index record contains the details of an index parameter set of at least one vehicle parameter corresponding to a parameter record. The index parameter set of a particular index record could also correspond to more than one vehicle parameter, each of which corresponded to a parameter record in the database. In addition to the index parameter set stored within the index record, the index record would also contain a reconditioning cost function. The reconditioning cost function as a stored mathematical function which correlates the historical reconditioning costs for historical reconditioning transactions of vehicles corresponding to the index parameter set with parameter values of a related reconditioned vehicle for cost records which have vehicle parameters within the historical parameter set whereby the stored mathematical reconditioning costs function when applied to current parameter values of the target vehicle corresponding to the index parameter set would yield an estimated reconditioning costs for the target vehicle predicted by historical reconditioning costs of similar reconditioned vehicles and transactions. Various types of mathematical functions could be used as reconditioning cost functions, dependent upon the nature of the available historical information stored within the cost records and the other aspects of operation of the database with the software of the present invention. Any type of a stored mathematical function which achieves the result of correlating the historical reconditioning costs with parameter values of the related precondition vehicle for cost records having vehicle parameters within their historical parameter sets corresponding to the eco-parameters of a target vehicle are all contemplated within the scope of the present invention.

The method of the present invention incorporates an index updating step which uses the modeling software component to update the reconditioning cost function in respect of one or more target index records by, on determining the existence of an index update condition, using a historical records set of cost records from the reconditioning database having vehicle parameters within their historical parameter sets that correspond to the vehicle parameters within the index parameter set of the target index record to establish or reestablish a reconditioning cost function based thereon, and storing the established, reestablished or updated reconditioning cost function to the database in association with the target index record. Various types of index update conditions might exist or occur. The reconditioning cost of the target vehicle can be estimated using the reconditioning index by using a computer and software in operative connection with the reconditioning index. The computer and software would capture parameter values and at least one vehicle parameter of a target vehicle, being a captured parameter set, from a user, or a remote computer system or the like. Based upon the captured parameter set a related index record will be identified in the reconditioning database which had vehicle parameters corresponding thereto which matched the vehicle parameters in the captured parameter sat. The reconditioning cost function associated with the related index record would then be applied to the parameter values of the captured parameter set to yield the results of the reconditioning cost function which would be the estimated reconditioning cost of the target vehicle.

This embodiment of the method of the present invention will result in a computer implemented creation of a parameter-based reconditioning index for use in the estimation of the target vehicles to a defined standard based upon the historical reconditioning cost of similar vehicles, which will be able to be used either on-site in context or could be used or deployed in a remotely accessed valuation system allowing for self-serve or dealership based access to a system allowing for reasonably accurate estimation of reconditioning cost of the vehicle, which could be used in conjunction with indexes of standards-based used vehicle valuation to estimate trade-in values of vehicles, by subtracting an accurately rendered reconditioning cost from that standards-based estimated used vehicle value. More specifically, the reconditioning cost of the target vehicle could be estimated using the reconditioning index of the above method by, using a computer and software in operative connection with the reconditioning index, first capturing parameter values of at least one vehicle parameter corresponding to a target vehicle. The parameter values captured are a captured parameter set. Effectively the index as outlined could contain more than one index record pertaining to different types of capture parameter sets, so that the index could be used to calculate reconditioning costs for different types of target vehicles or for target vehicles in respect of which different combinations of parameter values are captured.

Following the capture of a captured parameter set, the computer and software would identify related index record in the database which had vehicle parameters within the index parameter set corresponding to the vehicle parameters in the captured parameter set captured by the computer from a user or from another business system. Based on the selection of a related index record, the reconditioning cost function associated with that related index record can be applied to the parameter values from the captured parameter set to yield the result of the reconditioning cost function which is the estimated reconditioning cost of the target vehicle.

The system and method of the present invention in so far as it relates to updating of the index could conduct the index updating step off-line from the use of the reconditioning index in the estimation of reconditioning cost of target vehicles. In certain embodiments it will also be understood that a combination approach could be taken by the software and hardware where the necessary machine learning or similar software components required to execute the index updating step could be a component of the software used in the lookup aspect of the method and both such elements could be conducted by the same computer and system. Such approaches will be understood to be contemplated within the scope of the present invention—it is specifically contemplated that the off-line method is more likely to be used but both such approaches will be understood to be effective.

Many different types of reconditioning cost functions could be used or created, and the same type of reconditioning cost function would not need to be used for each index record. In some embodiments of the method of the present invention in the database, the same type of reconditioning cost function would be established and saved in respect of each different index parameter set, whereas in other embodiments and more desirably it will be understood that different types of reconditioning cost functions could be established based upon the nature of the parameters in the index parameter set as well as the nature of the data captured. Both such approaches are contemplated within the scope of the present invention.

In terms of the specific types of reconditioning cost functions, mathematical functions which could be applied to a parameter set to yield a result, which could be used, might comprise one or more of the following types of mathematical functions:
a. Linear Regression;
b. Naive Bayes Classification and Regression;
c. Ordinary Least Squares Regression;
d. Neural Networks;
e. Logistic Regression;
f. K-means Clustering;
g. Apriori Association Rule Learning;
h. Singular Value Decomposition;
i. Human Plausible Reasoning; or
j. Rough Sets.

It will be understood that the reconditioning cost functions which could be established and maintained by the software and method of the present invention could comprise any number of the above types of algorithms or mathematical functions, or others which have not been listed which will also be understood by those skilled in the art to be effective for the purpose of the execution of the method otherwise outlined herein.

It is specifically contemplated that the reconditioning cost function of a particular index record would be established based upon historical data corresponding to a number of historical vehicle reconditioning transactions and the related costs, for transactions in respect of which one or more vehicle parameters of the historical subject vehicles have been captured. It is contemplated that in certain embodiments of the method of the present invention, a reconditioning cost function could be established and maintained based upon a single vehicle parameter of the historical subject vehicles comprising the index parameter set, or in other embodiments or with respect to other index records within the database, the index parameter set could be made up of a plurality of vehicle parameters. In either case it is specifically contemplated that the at least one vehicle parameter of an index parameter set could be selected from the following group:
a. vehicle type;
b. vehicle manufacturer;
c. vehicle model;
d. vehicle model year;
e. vehicle odometer reading;
f. vehicle configuration options;
g. vehicle trim options;
h. vehicle identification number (VIN);
i. total reconditioning cost;
j. start and end date and time of reconditioning; and k. estimated reconditioning cost for the vehicle before the reconditioning was started.

It will be understood that any number of different types of vehicle parameters could be used within index parameter set or a captured parameter set—really the only limitation of the types of vehicle parameters which could be used would be parameters which could be captured in respect of a particular vehicle reconditioning cost and transaction at the time that the transaction information was captured, so that it could be used in the dataset of a particular index parameter set in the rendering of a related reconditioning cost function. Any type of such vehicle parameter which can be captured for use in an index parameter set or a related captured parameter set will be understood to be within the scope of the present invention.

In the system of the present invention it is specifically contemplated that by the rendering of a remotely usable method and software-based index, the method will provide the most accurate set of data points for use in the calculation of vehicle reconditioning cost. Specifically, the method of the present invention in terms of the establishment of a reconditioning index could be used by a single automotive dealership, although it is more likely and is explicitly contemplated that the method would be used in an embodiment where cost records used in the rendering of reconditioning cost functions would correspond to vehicles having been reconditioned by a plurality of reconditioning outlets. In some such embodiments the cost records could include an indication of the particular reconditioning element having conducted the reconditioning of the subject vehicle, so that cost records or related data points within the related reconditioning cost function could be identified to a particular reconditioning outlet.

In certain cases, for example based on geographic location, variance in the reconditioning standard, or other specific or customer related circumstances, a reconditioning cost function established for use in the remainder of the method of the present invention would accommodate the application of at least one cost modifier to the estimated reconditioning cost of a target vehicle. Effectively, it is contemplated that the cost modifiers could be mathematically or formulaically applied modifiers to the estimated reconditioning cost rendered by the reconditioning cost function. For example, if it was desired by a particular dealer or reconditioning outlet to modify the costs rendered by a reconditioning cost function by fixed percentage to accommodate some difference in their approach to resale, reconditioning or the like, or any number of other different types of cost modifiers could be contemplated for application. The types of cost modifiers which could be used could be selected non-exclusively from the list of user specific cost modifiers, geographic cost modifiers, subtotal labour costs, subtotal parts cost, estimated market value of the vehicle before reconditioning was started, accident and repair history modifiers, and average labour cost at the time or location of reconditioning to be conducted. Again, based on this nonexhaustive list of the types of cost modifiers which are contemplated to be used it will be understood the intention here that in the rendering of a estimated vehicle reconditioning cost in respect of a particular reconditioning outlet, it may be desired to apply mathematical modifications to those results outside of the result or the mathematical reconditioning cost function and any such type of modification is contemplated within the scope of the concept of cost modifiers and encompassed within the present invention.

As outlined above it is specifically contemplated in the method of the present invention that the database would be updated from time to time, specifically upon the determination of the existence of an index update condition. An index update condition, resulting in an update of one or more reconditioning cost functions stored in index records within the database could comprise a manual trigger—for example a manually triggered index update condition could be indicated by a client interface in communication with the server. Similarly, programmatically triggered index update condition could comprise a triggering indication for another computer in network communication with the server. Alternatively, the system could also be programmed to apply a preprogrammed time-based frequency trigger, or to trigger the creation or existence of an index update condition upon the addition or modification of cost records in the database. Again, all of these different types of index update conditions and underlying business conditions will be understood to those skilled in the art and all are contemplated within the scope of the present invention. The index update condition triggering an update of the database could apply to one or more of the index records in the database.

A reconditioning cost function stored in relation to an index record in the database could allow for estimation of reconditioning cost for a vehicle where the parameter values within a captured parameter set work outside of the range of historical parameter values to generate the function. It is specifically contemplated that the reconditioning cost functions could permit the rendering of reconditioning value results and where the parameter values in the captured parameter set were either within or outside of the range of historical data points used to develop and save the reconditioning cost function in question of the particular index parameter set/captured parameter set.

In addition to the computer implemented method of establishing a parameter based reconditioning index for use in the estimation of reconditioning costs of target vehicles to a defined standard, another embodiment of the present invention comprises a computer implemented method of estimating the cost of reconditioning to target vehicle to a defined standard using such a parameter based reconditioning index. That method comprises first providing a server comprising a processor and memory, along with an estimating software component for carrying out the steps of the method, and a reconditioning database.

The reconditioning database comprises a plurality of parameter records, each of which corresponds to a particular type of vehicle parameter in respect of which a value can be captured in respect to the target vehicle. Each parameter record will contain details of permissible parameter values. As will be understood from the content of this document and the scope outlined elsewhere herein, any type of the vehicle parameter capable of being captured is of value is contemplated within the scope of the present invention including something as simple as vehicle make, age, model, mileage or the like, through to other more granular parameters.

In addition to the plurality parameter records, the reconditioning database would also comprise a plurality of cost records. Each cost record corresponds to a historical reconditioning transaction of a reconditioned vehicle and contains the necessary information to be used in the remainder of the method to incorporate historical reconditioning costs of the particular type of vehicle into the mathematical functions generated and used in the reconditioning index. Each cost record would contain a parameter value in respect of the can reconditioned vehicle for a historical parameter set comprising at least one vehicle parameter corresponding to a parameter record in the reconditioning database. Many cost records might include parameter values for multiple parameters corresponding to multiple parameter records and will be understood to be within the scope of the present invention as well. In addition to the parameter values in respect of the rate reconditioned vehicle the subject of the historical reconditioning transaction, the cost record would also include the historical reconditioning costs associated with that transaction.

The reconditioning database would also comprise a plurality of index records. Each index record corresponds to a parameter-based index which can be used to generate historically informed reconditioning costs for target vehicles. Each index record contains the details of an index parameter set of at least one vehicle parameter corresponding to a parameter record. The index parameter set of a particular index record could also correspond to more than one vehicle parameter, each of which corresponded to a parameter record in the database. In addition to the index parameter set stored within the index record, the index record would also contain a reconditioning cost function. The reconditioning cost function as a stored mathematical function which correlates the historical reconditioning costs for historical reconditioning transactions of vehicles corresponding to the index parameter set with parameter values of a related reconditioned vehicle for cost records which have vehicle parameters within the historical parameter set whereby the stored mathematical reconditioning costs function when applied to current parameter values of the target vehicle corresponding to the index parameter set would yield an estimated reconditioning costs for the target vehicle predicted by historical reconditioning costs of similar reconditioned vehicles and transactions. Various types of mathematical functions could be used as reconditioning cost functions, dependent upon the nature of the available historical information stored within the cost records and the other aspects of operation of the database with the software of the present invention. Any type of a stored mathematical function which achieves the result of correlating the historical reconditioning costs with parameter values of the related precondition vehicle for cost records having vehicle parameters within their historical parameter sets corresponding to the eco-parameters of a target vehicle are all contemplated within the scope of the present invention.

The first step in the method of estimating the reconditioning cost of vehicle would comprise the use of a client interface in communication with the server to capture the parameter values of at least one vehicle parameter of the target vehicle from a user. The captured parameter values comprise a captured parameter set. The captured parameter set values would be transmitted to the server from the client interface.

Upon receipt of values corresponding to a captured parameter set at the server via a network interface from a client interface, the estimating software component would, upon disassembly or parsing of the values of the captured parameter set, identify a related index record having vehicle parameters within the index parameter set corresponding to the vehicle parameters in the captured parameter set. Effectively it is contemplated that multiple different types of parameter sets could be envisioned for capturing use in respect of the present invention and dependent upon the number and granularity of the parameters within an index parameter set the values which might be yielded from the application of reconditioning cost functions in accordance with the remainder of the method could be of higher precision where multiple parameters were used. Effectively it is contemplated that there would be an index record with an index parameter set associated therewith for each possible combination of captured vehicle parameters or captured parameter sets which could be received from the client interface at the server.

Once an index record with an index parameter set corresponding to the vehicle parameter contents of the captured parameter set was identified, the next step undertaken by the server and the estimating software component would be the application of the reconditioning cost function associated with that selected related index record to the parameter values of the captured parameter set, to yield the estimated reconditioning cost of the target vehicle. Finally, the estimated reconditioning cost of the target vehicle would be transmitted back to the client interface for display or further processing.

The client interface from which a captured parameter set would be received could either be a human interface of a client device in operative connection to the server via which either an automotive dealership or third-party customer seeking to accurately determine the reconditioning cost of a particular target vehicle could enter the vehicle parameter values in question—that human interface by way of for example web forms or other types of data capture could enforce the capture of certain types of combinations of vehicle parameters were certain particular captured parameter set values were desired for the purpose of yielding the best results of the method. Alternatively, the client interface mentioned in the claims and discussed above might not be a human interface but might be a network connection to another computer for example an unrelated business system or computer system of an automotive dealership which could transmit captured parameter set values from business systems of the automotive dealership or some third party to the server of the present invention for the execution of reconditioning cost value transactions. Such approaches i.e. either human interface for the capture of parameter values comprising a captured parameter set, or a machine to machine connection through which a remote computer could operatively connect to the server for the purpose of transmission of captured parameter set values, are both contemplated within the scope of the present invention.

As outlined above with respect to the generation of the index, this embodiment of the invention namely the method permitting for the calculation of a reconditioning cost estimate in respect of a particular target vehicle could incorporate in the step of the method applying the reconditioning cost function to the captured parameter set the application of at least one cost modifier in the yielding of the estimated reconditioning cost. Effectively, it is contemplated that the cost modifiers could be mathematically or formulaically applied modifiers to the estimated reconditioning cost rendered by the reconditioning cost function. For example if it was desired by a particular dealer or reconditioning outlet to modify the costs rendered by a reconditioning cost function by fixed percentage to accommodate some difference in their approach to resale, reconditioning or the like, or any number of other different types of cost modifiers could be contemplated for application. The types of cost modifiers which could be used could be selected non-exclusively from the list of user specific cost modifiers, geographic cost modifiers, subtotal labour costs, subtotal parts cost, estimated market value of the vehicle before reconditioning was started, accident and repair history modifiers, and average labour cost at the time or location of reconditioning to be conducted. Again, based on this nonexhaustive list of the types of cost modifiers which are contemplated to be used it will be understood the intention here that in the rendering of a estimated vehicle reconditioning cost in respect of a particular reconditioning outlet, it may be desired to apply mathematical modifications to those results outside of the result or the mathematical reconditioning cost function and any such type of modification is contemplated within the scope of the concept of cost modifiers and encompassed within the present invention. The cost modifiers which could be applied it is contemplated would specifically be useful for slight distributor specific formulaic adjustments to rendered reconditioning cost estimates which would incorporate for example local labour rates, geographic adjustments or the like.

As outlined above again with respect to the embodiments of the method rendering the index, mathematical functions which could be applied to a parameter set to yield a result, which could be used, might comprise one or more of the following types of mathematical functions:
a. Linear Regression;
b. Naive Bayes Classification and Regression;
c. Ordinary Least Squares Regression;
d. Neural Networks;
e. Logistic Regression;
f. K-means Clustering;
g. Apriori Association Rule Learning;
h. Singular Value Decomposition;
i. Human Plausible Reasoning; or
j. Rough Sets.

It is specifically contemplated that the reconditioning cost function of a particular index record would be established based upon historical data corresponding to a number of historical vehicle reconditioning transactions and the related costs, for transactions in respect of which one or more vehicle parameters of the historical subject vehicles have been captured. It is contemplated that in certain embodiments of the method of the present invention, a reconditioning cost function could be established and maintained based upon a single vehicle parameter of the historical subject vehicles comprising the index parameter set, or in other embodiments or with respect to other index records within the database, the index parameter set could be made up of a plurality of vehicle parameters. In either case it is specifically contemplated that the at least one vehicle parameter of an index parameter set could be selected from the following group:
a. vehicle type;
b. vehicle manufacturer;
c. vehicle model;
d. vehicle model year;
e. vehicle odometer reading;
f. vehicle configuration options;
g. vehicle trim options;
h. vehicle identification number (VIN);
i. total reconditioning cost;
j. start and end date and time of reconditioning; and
k. estimated reconditioning cost for the vehicle before the reconditioning was started.

It will be understood that any number of different types of vehicle parameters could be used within index parameter set or a captured parameter set—really the only limitation of the types of vehicle parameters which could be used would be parameters which could be captured in respect of a particular vehicle reconditioning cost and transaction at the time that the transaction information was captured, so that it could be used in the dataset of a particular index parameter set in the rendering of a related reconditioning cost function. Any type of such vehicle parameter which can be captured for use in an index parameter set or a related captured parameter set will be understood to be within the scope of the present invention.

The reconditioning cost functions stored in the index records in the database for use in accordance with the remainder of the invention could be mathematical functions which would permit accurate establishment of reconditioning costs for a target vehicle for parameter values outside of the range is defined by the data points in the historical dataset used to establish the particular reconditioning cost function. Functions allowing for establishment of estimated reconditioning cost for a target vehicle where the parameter values in the captured parameter set are either within or outside of the range is defined by the data points of the index parameter set used in the establishment of the reconditioning cost function are both contemplated within the scope of the present invention.

As outlined above, in the embodiments of the method of the present invention comprising a method of establishing the estimated reconditioning cost of a target vehicle to a defined standard, it is specifically contemplated that the reconditioning cost function of a particular index record would be established based upon historical data corresponding to a number of historical vehicle reconditioning transactions and the related costs, for transactions in respect of which one or more vehicle parameters of the historical subject vehicles have been captured. It is contemplated that in certain embodiments of the method of the present invention, a reconditioning cost function could be established and maintained based upon a single vehicle parameter of the historical subject vehicles comprising the index parameter set, or in other embodiments or with respect to other index records within the database, the index parameter set could be made up of a plurality of vehicle parameters.

It will be understood that any number of different types of vehicle parameters could be used within index parameter set or a captured parameter set—really the only limitation of the types of vehicle parameters which could be used would be parameters which could be captured in respect of a particular vehicle reconditioning cost and transaction at the time that the transaction information was captured, so that it could be used in the dataset of a particular index parameter set in the rendering of a related reconditioning cost function. Any type of such vehicle parameter which can be captured for use in an index parameter set or a related captured parameter set will be understood to be within the scope of the present invention.

In further embodiments of the present invention, the invention comprises a method of estimating the trade-in value of the target vehicle using a parameter based reconditioning index. The method is executed using a server comprising a processor and memory, along with an estimating software component for carrying out the steps of the method, and a reconditioning database. The reconditioning database comprises a plurality of parameter records, each of which corresponds to a particular type of vehicle parameter in respect of which a value can be captured in respect to the target vehicle. Each parameter record will contain details of permissible parameter values. As will be understood from the content of this document and the scope outlined elsewhere herein, any type of the vehicle parameter capable of being captured is of value is contemplated within the scope of the present invention including something as simple as vehicle make, age, model, mileage or the like, through to other more granular parameters.

In addition to the plurality parameter records, the reconditioning database would also comprise a plurality of cost records. Each cost record corresponds to a historical reconditioning transaction of a reconditioned vehicle and contains the necessary information to be used in the remainder of the method to incorporate historical reconditioning costs of the particular type of vehicle into the mathematical functions generated and used in the reconditioning index. Each cost record would contain a parameter value in respect of the can reconditioned vehicle for a historical parameter set comprising at least one vehicle parameter corresponding to a parameter record in the reconditioning database. Many cost records might include parameter values for multiple parameters corresponding to multiple parameter records and will be understood to be within the scope of the present invention as well. In addition to the parameter values in respect of the rate reconditioned vehicle the subject of the historical reconditioning transaction, the cost record would also include the historical reconditioning costs associated with that transaction.

The reconditioning database would also comprise a plurality of index records. Each index record corresponds to a parameter-based index which can be used to generate historically informed reconditioning costs for target vehicles. Each index record contains the details of an index parameter set of at least one vehicle parameter corresponding to a parameter record. The index parameter set of a particular index record could also correspond to more than one vehicle parameter, each of which corresponded to a parameter record in the database. In addition to the index parameter set stored within the index record, the index record would also contain a reconditioning cost function. The reconditioning cost function as a stored mathematical function which correlates the historical reconditioning costs for historical reconditioning transactions of vehicles corresponding to the index parameter set with parameter values of a related reconditioned vehicle for cost records which have vehicle parameters within the historical parameter set whereby the stored mathematical reconditioning costs function when applied to current parameter values of the target vehicle corresponding to the index parameter set would yield an estimated reconditioning costs for the target vehicle predicted by historical reconditioning costs of similar reconditioned vehicles and transactions. Various types of mathematical functions could be used as reconditioning cost functions, dependent upon the nature of the available historical information stored within the cost records and the other aspects of operation of the database with the software of the present invention. Any type of a stored mathematical function which achieves the result of correlating the historical reconditioning costs with parameter values of the related precondition vehicle for cost records having vehicle parameters within their historical parameter sets corresponding to the parameters of a target vehicle are all contemplated within the scope of the present invention.

The server would also be operatively connected to a trade-in data source which comprised a plurality of trade-in records each of which corresponded to a net trade-in value for a particular type of vehicle.

The first step of calculating the trade-in value of a particular target vehicle would comprise the initiation of an estimation transaction in respect of the target vehicle at the server when data is received at the server from a client device which corresponds to the parameter values of at least one vehicle parameter of the target vehicle, being a captured parameter set, and the vehicle type of the target vehicle. This is the data capture step of the method.

On receipt of such a transmission and the initiation of an estimation transaction, the server would conduct a look above the net trade-in value for the target vehicle from the trade-in data source, using the vehicle type of the target vehicle included in the data received.

The next step of the method as shown is to identify a related index record which has vehicle parameters within the index parameter set corresponding to the vehicle parameters in the captured parameter set. Multiple different types of parameter sets could be envisioned for capturing use in respect of the present invention and dependent upon the number and granularity of the parameters within an index parameter set the values which might be yielded from the application of reconditioning cost functions in accordance with the remainder of the method could be of higher precision where multiple parameters were used. Effectively it is contemplated that there would be an index record with an index parameter set associated therewith for each possible combination of captured vehicle parameters or captured parameter sets which could be received from the client interface at the server.

Once an index record with an index parameter set corresponding to the vehicle parameter contents of the captured parameter set was identified, the next step undertaken by the server and the estimating software component would be the application of the reconditioning cost function associated with that selected related index record to the parameter values of the captured parameter set, to yield the estimated reconditioning cost of the target vehicle.

The trade-in value of the target vehicle would be calculated by the software component by subtracting the estimated reconditioning cost from the net trade-in value of the target vehicle, and in the final step of the estimation transaction the trade-in value of the target vehicle would be transmitted to the initiating client device for display or further processing. The client interface from which a captured parameter set would be received could either be a human interface of a client device in operative connection to the server via which either an automotive dealership or third-party customer seeking to accurately determine the reconditioning cost of a particular target vehicle could enter the vehicle parameter values in question—that human interface by way of for example web forms or other types of data capture could enforce the capture of certain types of combinations of vehicle parameters were certain particular captured parameter set values were desired for the purpose of yielding the best results of the method. Alternatively, the client interface mentioned in the claims and discussed above might not be a human interface but might be a network connection to another computer for example an unrelated business system or computer system of an automotive dealership which could transmit captured parameter set values from business systems of the automotive dealership or some third party to the server of the present invention for the execution of reconditioning cost value transactions. Such approaches i.e. either human interface for the capture of parameter values comprising a captured parameter set, or a machine to machine connection through which a remote computer could operatively connect to the server for the purpose of transmission of captured parameter set values, are both contemplated within the scope of the present invention.

The method of calculation of the trade-in value of the target vehicle could incorporate the application of at least one cost modifier to the result of the applied reconditioning cost function in the yielding of the estimated reconditioning cost. The types of cost modifiers which could be used could be selected non-exclusively from the list of user specific cost modifiers, geographic cost modifiers, subtotal labour costs, subtotal parts cost, estimated market value of the vehicle before reconditioning was started, accident and repair history modifiers, and average labour cost at the time or location of reconditioning to be conducted. Again, based on this nonexhaustive list of the types of cost modifiers which are contemplated to be used it will be understood the intention here that in the rendering of a estimated vehicle reconditioning cost in respect of a particular reconditioning outlet, it may be desired to apply mathematical modifications to those results outside of the result or the mathematical reconditioning cost function and any such type of modification is contemplated within the scope of the concept of cost modifiers and encompassed within the present invention.

Mathematical functions which could be applied to a parameter set to yield a result, which could be used, might comprise one or more of the following types of mathematical functions:
k. Linear Regression;
l. Naive Bayes Classification and Regression;
m. Ordinary Least Squares Regression;
n. Neural Networks;
o. Logistic Regression;
p. K-means Clustering;
q. Apriori Association Rule Learning;
r. Singular Value Decomposition;
s. Human Plausible Reasoning; or
t. Rough Sets.

It is specifically contemplated that the reconditioning cost function of a particular index record would be established based upon historical data corresponding to a number of historical vehicle reconditioning transactions and the related costs, for transactions in respect of which one or more vehicle parameters of the historical subject vehicles have been captured. The reconditioning cost functions stored in the index records in the database for use in accordance with the remainder of the invention could be mathematical functions which would permit accurate establishment of reconditioning costs for a target vehicle for parameter values outside of the range is defined by the data points in the historical dataset used to establish the particular reconditioning cost function. Functions allowing for establishment of estimated reconditioning cost for a target vehicle where the parameter values in the captured parameter set are either within or outside of the range is defined by the data points of the index parameter set used in the establishment of the reconditioning cost function are both contemplated within the scope of the present invention.

### BRIEF DESCRIPTION OF THE DRAWINGS

While the invention is claimed in the concluding portions, preferred embodiments are provided in the detailed description which may be best understood with the diagrams where like parts in each of the several diagrams are labeled with like numerals, and where:

FIG. 1 is a block diagram showing the components of one embodiment of a system which could be used in the method of establishment of a parameter based index in accordance with the present invention;

FIG. 2 is a block diagram showing the components of one embodiment of the server of FIG. 1;

FIG. 3 is a diagram showing a sample of a data structure of the database of the embodiment of FIG. 1;

FIG. 4 is a flowchart demonstrating the steps of one embodiment of a method of creation of a parameter based reconditioning index in accordance with the present invention;

FIG. 5 is a flowchart demonstrating the steps of one embodiment of a method of updating the index created in accordance with the method of FIG. 4;

FIG. 6 is a block diagram showing the components of one embodiment of a system which could be used in the method of establishment of a particular estimated reconditioning cost for a target vehicle in accordance with the present invention;

FIG. 7 is a flowchart demonstrating the steps in one embodiment of a method of the present invention for the estimation of the cost of reconditioning a target vehicle to a defined standard using a parameter based reconditioning index;

FIG. 8 is a block diagram showing the components of the one embodiment of a system which could be used in the method of establishment of the trade-in value of a target vehicle in accordance with the method of the present invention;

FIG. 9 is a flowchart demonstrating the steps in one embodiment of a method of the present invention estimation of the trade-in value of the target vehicle;

FIG. 10 is an exemplary depiction of a linear regression model that provides linear correlation between the reconditioning costs to the odometer reading of the vehicle;

FIG. 11 depicts an exemplary user display that may be employed in transmitting and displaying estimated reconditioning cost(s) to a user; and

FIG. 12 depicts transforming the reconditioning cost of, for example, dealerships that might have the capability of setting one or more parameters that force a percentage of the estimated reconditioning cost by model to be included in the valuation and be shown to the customer.

### DETAILED DESCRIPTION

As outlined above, the present invention pertains to the creation of a parameter based reconditioning index for use in the estimation of the reconditioning cost of target vehicles to a defined standard based upon historical reconditioning data and the use of that index in the estimation of reconditioning cost and vehicle trade-in values. The following provides further detail of the intended scope and some demonstrative embodiments of the present invention.

Reconditioning Cost:

As outlined in further detail above, the reconditioning cost of the vehicle is a key determination in estimating the amount of money which can be provided by a automotive dealership as a trade-in value for a used vehicle—since most dealerships would reconditioning used vehicles taken an entrée to at least a particular standard before they would make them available for resale. The reconditioning costs of vehicles could include everything from the cost of washing or detailing the exterior or interior of the vehicle, fixing paint chips, replacing tires, windows or other parts. There is typically a defined standard dealerships would use to recondition a vehicle to—for most dealerships the standard of reconditioning would be similar in terms of reconditioning of vehicle to a general level of salability and road worthiness.

As outlined above, in many historical circumstances, the reconditioning cost for a vehicle would be estimated by having a dealership employee physically review the vehicle and identify items requiring attention or replacement. Often one of the key parameters of the vehicle which would be used by human estimators and past circumstances to get a ballpark idea of reconditioning cost would be the mileage of the vehicle coupled with its type or model etc. It is intended and desired in the present invention to come up with a method of estimating with a high degree of accuracy the anticipated reconditioning cost of the target vehicle to a defined standard, without the need for personal inspection based upon the capture of one or more objective parameters in relation to the vehicle, using a mathematical model created with historical data from similar reconditioning transactions.

Once the reconditioning cost of the vehicle to the desired or defined standard is determined, that can be used then to estimate the likely net trade-in value that the dealership would be prepared to provide to a customer on a trade-in by subtracting the anticipated reconditioning cost from a predetermined type based value.

Vehicle Parameters:

As outlined above, one of the key condition parameters of a vehicle which could be used to provide the ability to generally estimate reconditioning cost has often in the past been the mileage of the vehicle. The mileage of the vehicle is a demonstrative vehicle parameter.

It is contemplated that the method of the present invention would explicitly rely upon the capture of one or more vehicle parameters with respect to the target vehicle for which a reconditioning cost or trade-in value with the desired to be calculated. Many different types of vehicle parameters are contemplated all of which could be “objective” from the perspective that they could be captured quantitatively or without the need for a physical inspection of the vehicle. As outlined in greater detail throughout, the vehicle parameters which could be used to select mathematical models or relevant historical data from the perspective of assessing reconditioning cost could be selected from the following group:
a. vehicle type;
b. vehicle manufacturer;
c. vehicle model;
d. vehicle model year;
e. vehicle odometer reading;
f. vehicle configuration options;
g. vehicle trim options;
h. vehicle identification number (VIN);
i. total reconditioning cost;
j. start and end date and time of reconditioning; and
k. estimated reconditioning cost for the vehicle before the reconditioning was started.

Any of these types of parameters outlined above or others which might be obvious to those skilled in the art of equal value assessment will be understood to be relevant from the perspective of generally speaking ascertaining the type and cost associated with reconditioning of a particular target vehicle. In the most basic embodiments it is contemplated that it would be desirable to deliver an index in accordance with the method of the present invention that would allow for the estimation of reconditioning cost of a vehicle based only on the vehicle odometer reading, as a way of most quickly providing a mileage-based value assessment for any type of vehicle based on mileage on the vehicle, and it will be understood that as additional parameters were used to narrow down the relevant data, the accuracy of the reconditioning cost yielded by such a calculation will be enhanced.

Index Parameter Sets:

It is specifically contemplated that the index of the present invention will permit the assessment of estimated reconditioning cost for target vehicles based upon certain predetermined combinations of vehicle parameters which might be captured. One or more vehicle parameters might make up an index parameter set—for example it might be desired to have the ability to have one reconditioning cost function established with respect to a single parameter index parameter set on for example the odometer reading of the vehicle, and it might be desired to have one or more additional index parameter sets that added more vehicle parameters resulting in a more granular data treatment and a more accurate estimation of reconditioning cost—for example additional index parameter sets might include the vehicle year, odometer reading, model number configuration options, and the like. It will be understood that any number of index parameter sets, each of which might comprise any number of vehicle parameters pertaining to a particular target vehicle to be assessed could be used and established in accordance with index records in the database and any such number of index parameter sets and corresponding records and mathematical functions are all contemplated within the scope of the present invention.

Captured Parameter Sets:

The vehicle parameters captured by a user or a customer with respect to a particular target vehicle, and based upon which the reconditioning cost is to be assessed, are captured parameters. The captured parameters which are captured in respect of a particular target vehicle make up a captured parameter set. The number and type of vehicle parameters within a particular captured parameter set should correspond to an index parameter set associated with the particular index record in the database. For example, if a customer were to enter the manufacturer, model, and odometer as three captured parameters through a human client interface and seek the establishment of the estimated reconditioning cost of that vehicle, the captured parameter set made up of the three parameters being the manufacturer, model and odometer reading should correspond to a index parameter set comprised of the same three parameters which will have a mathematical function associated therewith.

Historical Reconditioning Data:

The method of the present invention revolves around establishing one or more reconditioning cost functions which are mathematical functions which can be used when applied to a particular set of captured parameter values in respect of a target vehicle to yield an estimated reconditioning cost based upon historical transactions of similar types of reconditioning. Historical reconditioning transactions which could be captured and memorialized in database records for use in the rendering of mathematical functions in accordance with the remainder of the method of the present invention could be any type of a vehicle reconditioning transaction which resulted in the reconditioning of a particular target vehicle to the defined standard which was desired to be used as the reconditioning baseline for the practice of the method of the present invention, and in respect of which one or more vehicle parameters historically were captured or could be assigned to that record in respect of the target vehicle which was reconditioned. The data pertaining to a particular historical reconditioning transaction will be more valuable as the number of additional types of vehicle parameters captured in respect of the target vehicle reconditioned in that historical transaction is increased, since that particular historical transaction and a corresponding data record could then be used in the building of a higher number of reconditioning cost functions for use in accordance with the remainder of the method of the present pension.

Details a particular historical reconditioning transactions could be captured and transposed from paper or off-line accounting records in certain embodiments of the method of the present invention or more likely could be captured in data extraction from point-of-sale or accounting systems and vehicle dealerships which would easily characterize or capture all of the necessary parameter information for association with the historical record and cost associated with a particular transaction.

Reconditioning Cost Functions:

The reconditioning cost function is at the core of the present invention. The reconditioning cost function is effectively a mathematical function, model or formula which will be established by software operable on the server and stored in relation to a particular index parameter set for use to determine the estimated reconditioning cost of a particular target vehicle.

Mathematical functions which could be applied to a parameter set to yield a result, which could be used, might comprise one or more of the following types of mathematical functions:
a. Linear Regression;
b. Naive Bayes Classification and Regression;
c. Ordinary Least Squares Regression;
d. Neural Networks;
e. Logistic Regression;
f. K-means Clustering;
g. Apriori Association Rule Learning;
h. Singular Value Decomposition;
i. Human Plausible Reasoning; or
j. Rough Sets.

The software method of the present invention contemplates a modelling software component which is executable server, capable of rendering one or more mathematical functions for storage and application to captured parameter sets to yield estimated reconditioning costs. It will be understood that the software itself could be any type of software capable of determining the appropriate mathematical function or algorithmic approach to be taken to a particular set of data, including the types of mathematical functions outlined above.

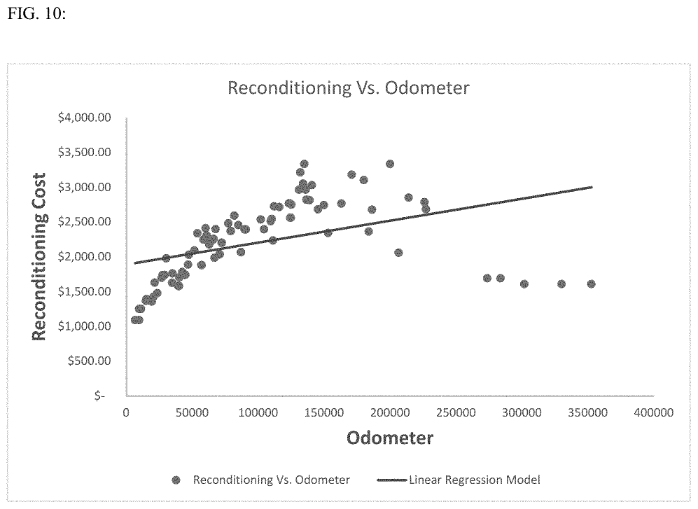

For instance and as further shown in FIG. 10, in the simplest form a linear regression model creates linear correlation between the reconditioning costs to the odometer reading of the vehicle, where the Y axis represents the reconditioning costs and the x-axis represents the corresponding odometer reading. The reconditioning cost function or model in this case would be a line, so that the sum of the square of the distances of each and every data point, represented by the odometer as x-axis and the reconditioning cost is the Y-axis is the minimum. The chart in FIG. 10 demonstrates such a sample of a reconditioning cost function.

Cost Modifiers:

As outlined throughout is specifically contemplated that either as a component of the reconditioning cost function itself or as a supplemental calculation following the rendering of a result from the reconditioning cost function associated with the index record corresponding to a captured parameter set, local cost modifiers could be applied to modify the estimated reconditioning cost of the target vehicle.

The cost modifiers could be mathematically or formulaically applied modifiers to the estimated reconditioning cost rendered by the reconditioning cost function. For example if it was desired by a particular dealer or reconditioning outlet to modify the costs rendered by a reconditioning cost function by fixed percentage to accommodate some difference in their approach to resale, reconditioning or the like, or any number of other different types of cost modifiers could be contemplated for application. The types of cost modifiers which could be used could be selected non-exclusively from the list of user specific cost modifiers, geographic cost modifiers, subtotal labour costs, subtotal parts cost, estimated market value of the vehicle before reconditioning was started, accident and repair history modifiers, and average labour cost at the time or location of reconditioning to be conducted. Again, based on this nonexhaustive list of the types of cost modifiers which are contemplated to be used it will be understood the intention here that in the rendering of a estimated vehicle reconditioning cost in respect of a particular reconditioning outlet, it may be desired to apply mathematical modifications to those results outside of the result or the mathematical reconditioning cost function and any such type of modification is contemplated within the scope of the concept of cost modifiers and encompassed within the present invention. The cost modifiers which could be applied it is contemplated would specifically be useful for slight distributor specific formulaic adjustments to rendered reconditioning cost estimates which would incorporate for example local labour rates, geographic adjustments or the like.

Method Overview—Building the Index:

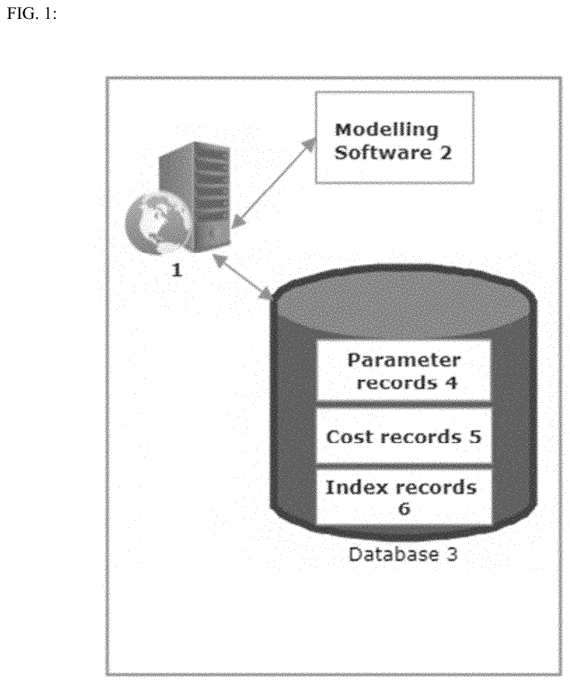

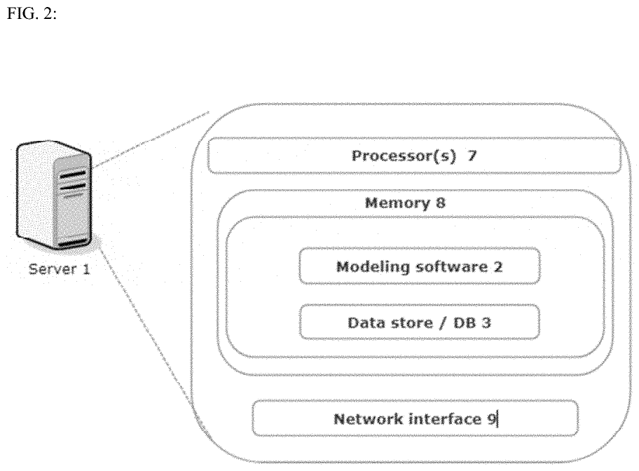

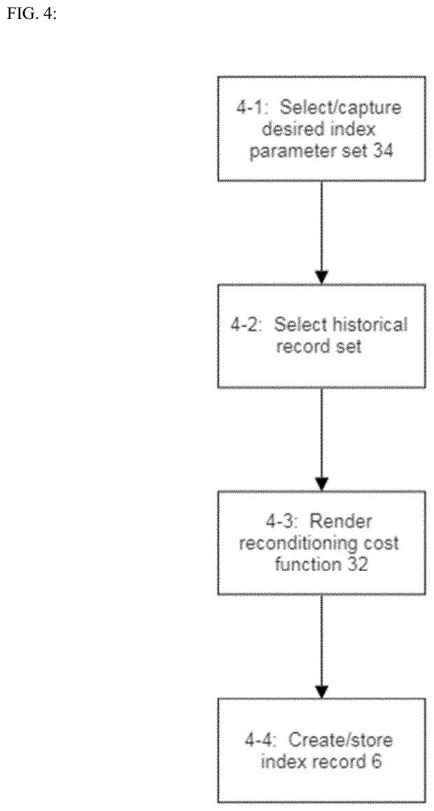

Turning first to FIG. 4 there is shown a flow chart identifying the general steps of a method of establishing an index record 6 in accordance with the present invention. The server 1 and modelling software component 2, in communication with the database 3, would be used in the execution of this aspect of the method. FIG. 1 and FIG. 2 demonstrate a system and server 1 which could be used in the execution of the method of building and updating the index as outlined below. The server 1, sample embodiment of which is shown in FIGS. 1 and 2, might consist of one or more servers 1—a single server or a server farm approach. Server 1 would comprise one or more processors 7 and memory 8. The memory 8 might include various processor instructions for the method of the present invention or otherwise operating the server 1. Processor instructions corresponding to the modelling software component 2 are shown stored within the memory 8 in this Figure. The server 1 can be configured by machine-readable instructions which might include one or more instruction components. The instruction components might include one or more of server firmware or operating systems, the modelling software component 2 and/or other instruction components.

The memory 8 might comprise non-transitory storage media that electronically stored information. Electronic storage media memory 8 might include one or both of system storage provided integrally with the server 1 and/or removal or connectable storage removably connected to the server 1 via for example a port or a drive. Memory 8 might also include one or more optically readable storage media, magnetically readable storage units, electric charge based storage media, solid-state storage media or other electronically readable storage media. The memory 8 may include one or more virtual storage resources i.e. cloud storage, VPN or the like and the memory 8 may store software algorithms, and information determined by processors 7, information received from service, or otherwise to function as outlined herein.

The processor 7 may be configured to provide information processing capabilities in the server 1. The processor 7 might include one or more of a digital processor, an analog processor, a digital circuit design and process information or analog circuit designs to process information, state machine and/or other mechanisms for electronically processing information. Although the processor 7 is shown as a single entity, this is for illustrative purposes only—in some implementations the processor 7 might include a plurality of processing units physically within the same device or might also represent processing functionality of a plurality of devices operating in coordination.

In many embodiments, the server 1 is contemplated to be a Web server which might also include a network interface 9, whereby client devices could communicate therewith.

The server 1 would also be operatively connected to a data store 3 besides the general operating system instructions, the server and seven would come rise also a modelling software component 2 responsible for execution of the process and method of certain embodiments of the present invention. The modelling software component 2 itself might act as the interface between the remainder of the hardware and software of the server 1 and the data store 3, or the server 1 might also include additional software interfaces to the data store 3.

The primary software component operable on the server 1 for the purpose of the conduct of the present embodiment of the method of the present invention is a modelling software component 2. The modelling software component, as will be understood to those skilled in the art of computer programming, would comprise processor instructions executable upon the processors 6 of the server 1 for the purpose of executing the steps of the method of the present invention.

Specifically, it is contemplated that the modelling software component 2 contain the necessary mathematical modelling components to allow for the calculation, establishment or modification of reconditioning cost functions 32 as required. Mathematical modelling functionality and computer software will be understood to those skilled in the art, and a mathematical modelling engine could be built into the software 2 of the present invention or mathematical modelling components could be connected in an operable way with the remainder of the software 2 and both such approaches are contemplated within the scope of the present invention.

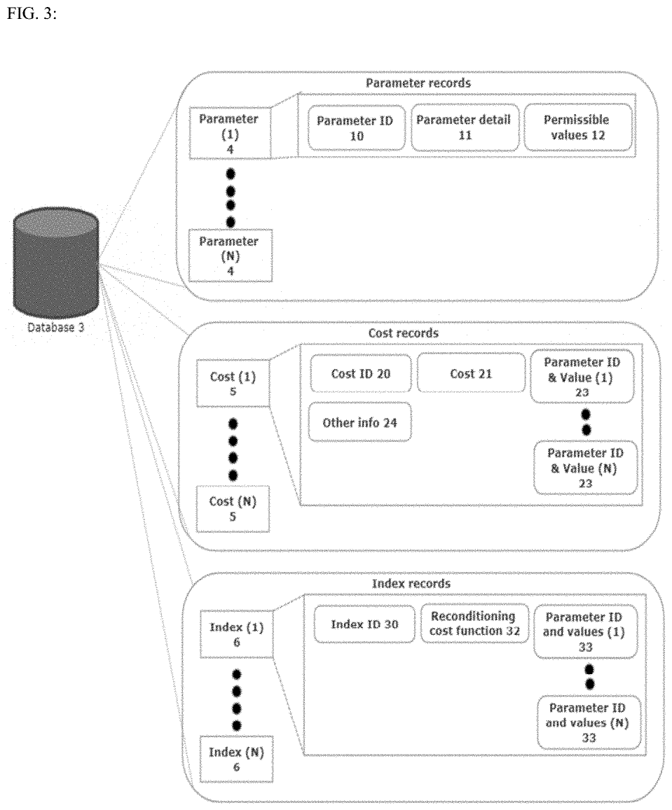

FIG. 3 demonstrates one block diagram or schematic of a database design for the database 3 of the present invention in accordance with the remainder of the invention outlined herein. Referring to that Figure there is shown a database 3 comprised of three record subsets, namely a subset of parameter records 4, a subset of cost records 5, and a subset of index records 6. The database 3 or other accompanying data repository might also include the storage of additional data required for execution of varying embodiments of the general methodology of the present invention but it will be understood as outlined herein that this type of a general data structure with modifications as understood to those skilled in the art will form the basis and core of the invention.

Referring first of the subset of parameter records 4. As will be understood from the remainder of the specification and commentary outlined herein, there could be a large number of different types of vehicle parameters which could be configured for use in accordance with the remainder of the method of the present invention. A parameter record 4 would be created in this database 3 for each vehicle parameter it was desired to track. A sample data structure for the parameter records 4 is shown. For example, database key or a parameter ID 10 is shown along with parameter details 11. The parameter details 11 might comprise a label or other information required for storage, reporting or calculation purposes. A range of permissible values 12 could also be stored in respect of each parameter record 4 and is shown. Effectively the cost records 5, the index records 6 and other elements of the software of the present invention will link back to these parameter records 4 as providing a standardization basis for reference to vehicle parameter values within a captured parameter set or an index parameter set. In addition to or in the place of certain of the fields shown with respect to the parameter record 4, it will be understood that additional fields could be added or alternate fields could be created to capture or maintain additional or alternative information which might be desired to be stored for use in respect of certain embodiments of the method of the present invention at all such approaches are contemplated within the scope hereof.

Also shown is a plurality of cost records 5. Each cost record 5 corresponds to a historical vehicle reconditioning transaction and represents historical data which can be used for the establishment or update of certain reconditioning cost functions 32 stored in the database and used throughout the remainder of the method. As in the case of the parameter records 4, a plurality of cost records 5 is also shown. It is explicitly contemplated that as a particular database 3 in accordance with the present invention was populated, a large number of cost records 5 would be created or stored.

Dependent upon the data structure of the database 3, each cost record 5 might require a record key or a cost ID 20. Additionally, the key aspect of the cost record 5 is a stored value of the reconditioning transaction cost 21 i.e. the amount of cost that was incurred to recondition the target vehicle subject of that transaction to the defined standard. Other information in respect of the transaction 24 might also be desired to be captured or stored or reporting, data checking or verification or other purposes and any other type of information 24 which was captured in respect of a particular historical reconditioning transaction which it was desired to store it in the database will be understood to be within the scope of information which could be stored in fields such as that demonstrated with respect to the other information field 24.

Also shown with respect to the cost record 5 is a series of vehicle parameters and parameter values in respect of the particular target vehicle which was the subject of the historical transaction. In order for the standardized vehicle parameter approach of the entire method of the present invention to be applied in the use of the historical transaction costs 21 stored within the various cost records 5, it is required to have at least one or more parameter IDs and values 23 stored which could be used for the purpose of comparing and matching particular cost records 5 to the particular index parameter sets of particular target index records 6 in respect of which reconditioning cost functions 32 were being created or maintained. The parameter IDs as shown at 23 would be in the context of a typical relational database configuration likely correspond to the parameter IDs 10 of parameter records 4 stored in the database 3. For example, parameters stored with respect to a particular cost record might include the vehicle manufacturer name, and the odometer reading—in the case of a particular historical reconditioning transaction in respect of which only those two parameter values were captured. Other historical transaction information related to particular cost records 5 might include a far larger number of parameter IDs and values 23. Specifically it is contemplated that where cost records 5 included a high number of parameter IDs and values 23 that particular cost record 5 could be used as a part of a historical record set for the establishment or maintenance of many different reconditioning cost functions 32 corresponding to multiple index records 6, each of which had index parameter sets with varying numbers of parameters associated therewith.

Also shown is a plurality of index records 6. Each index record 6 corresponds to a particular index planner set, being a particular grouping of vehicle parameters which correspond to a particular reconditioning cost function 32. As shown with respect to the other data subsets of cost records 5 and parameter records 4, the relational database shown in this Figure includes demonstration of the database key or an index ID 30 with respect to each index record 6. Also shown is a stored reconditioning cost function 32 which would comprise the necessary data or instructions to be executed by the processor 6 of the server one in the application of a particular mathematical function to a particular captured parameter set to yield a particular estimated reconditioning cost. As discussed elsewhere herein, each index record 6 would also include the details of an index parameter set associated with the particular related reconditioning cost function 32. As shown in this particular Figure, the index parameter set would be defined in respect of the particular index record 6 by including in the data structure and indication of the parameter ID 33 of each vehicle parameter which it was desired to include within the vehicle parameter set. In some embodiments of the database 3, the index record might only include the parameter ID, which would match up to parameter records 4 by their parameter ID 10. In other embodiments, the parameter ID 33 might also be stored alongside permissible values in respect of that particular parameters, so that the relevant cost records 5 establishing or maintaining the recondition cost function 32 could be effectively filtered or selected. Both such approaches are contemplated within the scope of the present invention.

It will be understood that in addition to the details of the software instructions required to execute a particular reconditioning cost function 32 against the captured parameter set, additional fields could also be included within or in relation to a particular index record 6. It will also be understood that the reconditioning cost functions 32 might in certain circumstances be stored in a related or interconnected data repository, to be accessed and called for execution at the appropriate time in accordance with the remainder of the method of the present invention and all these modifications would be understood to those skilled in the art of data structure design and computer program such as that outlined herein and all such changes as would be obvious to those skilled in the art are contemplated within the scope of the present invention.

Referring now to FIG. 4 there are shown the steps in one embodiment method of the creation of a reconditioning cost function 32 to be stored and used in respect of recognition cost estimate transactions in accordance with the remainder of the method of the present invention. Shown at step 4-1, the details of a particular desired index parameter set 34 would be selected or captured from the user. This could be done via a client interface in connection and operation with the server or otherwise. The details of the desired index parameter set 34 would likely correspond to a selection of one or more parameter records 4 in the database 3 as outlined above, along with any values or value ranges to be used to further delimit the index parameter set and to be stored in association with the parameter IDs 33.

Once the desired index parameter set 34 is selected or captured from a client device or user, the modelling software component 2 would, via execution of queries against the database 3, select I historical record set, being a subset of the cost records 5 stored within the database 3 which matched the parameter IDs and permissible values of the desired index parameter set 34 captured in the step above.

With a historical record set of cost records 5 having been identified, the math modelling component of the modelling software component 2 would use the contents of the historical record set, namely the reconditioning cost of the related historical reconditioning transactions and any other necessary or required parameter values associated with the record or transaction, to establish a mathematical function which could be used to determine a estimated reconditioning cost for a current target vehicle based on historical data by applying said function to captured parameter set, representing parameters and parameter values corresponding to the index parameter set 34. As outlined above, the recondition cost function 32 could be one of any number of different kinds of mathematical functions, having for example any number of axes or plotting directions which would allow for an estimated software component capable of applying this function to determine the placement of a particular set of captured parameter values for the purpose of estimating the recondition cost of the vehicle. All of the recondition cost functions 32 stored in respect of each index record 36 could be modified versions of the same type of a mathematical function, modified based upon the contents of the historical record set, or certain of the recondition cost functions 32 stored in respect of certain index records 6 could be different types of mathematical functions. The math modelling component of the modelling software, as will be understood to those skilled in the art, could actually also render multiple types of mathematical functions based upon the historical record set and then assess them together for the selection of the most accurate reconditioning cost function 32. The rendering of the reconditioning cost function 32 based upon the selected historical record set is shown at step 4-3.

Once the recondition cost function 32 has been determined in respect of the selected historical record set such that it can be used in future cost calculations, the software would create or save an index record 6 to the database 3 computing the details of the desired index parameter set 34 and the rendered reconditioning cost function 32. This is shown at step 4-4. Following the execution of the transaction of this nature by the software on the server, the database 3 would be populated with an additional index record 6 corresponding to a new index parameter set 34.

Method Overview—Updating the Index:

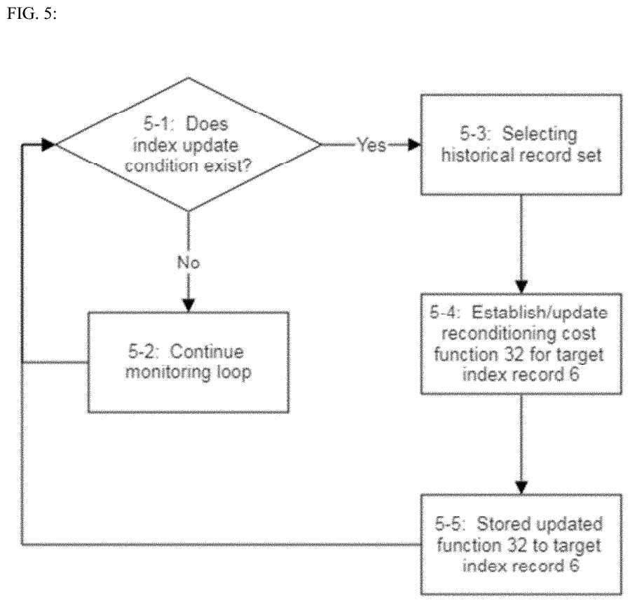

Referring now to FIG. 5 there is shown a flowchart representing the steps in one embodiment of a method in accordance with the claimed invention for the conduct of an update of one or more index records 6 of the database 3. The modelling software component 2 would monitor via a listening loop or otherwise to detect the existence of an index update condition in respect of one or more index records 6. An index update condition would be a detectable condition based upon which the modelling software component 2 would trigger the update of the recondition cost function 32 associated with a particular index record 6 based upon the then current contents of the cost records 5 in the database 3. Various types of a next update conditions could be used to trigger updates to one or more index records 6 in the database. A manual trigger could be received by the server 1 from a client interface or network connected computer or other device, or other cases the modelling software component 2 could also be programmed to execute a periodic update thus triggering the existence of a periodic index update condition resulting in a particular frequency of database updates taking place. What is also specifically contemplated to comprise an index update condition would be the creation of additional cost records 5 in the database 3—it is specifically contemplated that the server 1 might receive via other software components information for the creation of additional cost records 5 on an ongoing real-time or periodic basis from connected third-party computers or computer systems. In such a case, when the addition of cost records 5 or cost records pertaining to a particular index parameter set 34 are detected within the database 3 that could comprise an index update condition resulting in a need for the update of one or more index records 6.

The embodiment of the listening loop and the index update method shown in this Figure comprises a decision block at 5-1, indicating a state in which the modelling software component 2 would listen or stand for the detection of the existence of an index update condition. The details of different types of index update conditions at least in a demonstrative sense are outlined above. If no index update condition exists, the monitoring loop continues, as shown at 5-2.

When the software 2 does detect the existence of an index update condition with respect to one or more index records 6, the yes leg of the 5-1 decision block is followed. An index update condition in existence in relation to the method of the present invention could relate to the triggering or requirement of an index update with respect to only one index record 6 in the database 3 or with respect to a plurality or all of the index records 6 within the database 3.

On the detection of the existence of an index update condition in respect of at least one index record 6, being the target index record 6, the modelling software component 2 would conduct a method of first selecting a historical record set being a set of cost records 5 from the database 3 based upon the index parameter set 34 associated with the target index record 6. Following the selection of the historical record set at 5-3, the modelling software component 2 would use the up-to-date contents of the historical record set to update the recondition cost function 32 of the target index record 6. Basically, as new historical data is received and logged into the cost records 5 within the database 3 each new tranche of data can be used to enhance the accuracy of the recondition cost functions 32 relying on those particular records or relying on records pertaining to a particular index parameter set 34 touched upon by the cost records 5 in question. Updating the recondition cost function 32 using the mathematical modelling aspects of the modelling software component 2 is shown at step 5-4. Finally, the updated recondition cost function 32 would be stored to the targeting next record 6, shown at 5-5. The update steps shown at 5-3 through 5-5 would be conducted in respect of each target index record 6 in respect of which the index update condition exists.

Embodiments of the invention similar to those outlined in FIGS. 4 and 5 outline the creation and maintenance of a reconditioning cost index for use in the estimation of recondition cost of target vehicles based on historical data values. The present invention also encompasses the use of the related recondition cost index for the estimation of the recondition cost of particular target vehicles or the trade-in values of target vehicles, the details of such further methods of embodiments being next outlined.

Method Overview—Estimation of Reconditioning Cost:

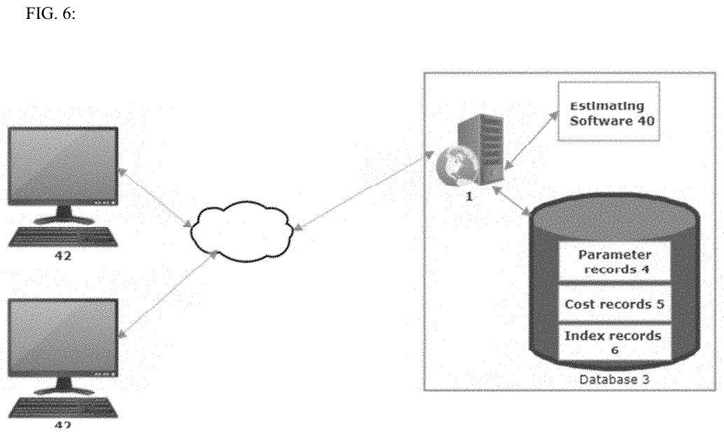

FIG. 6 demonstrates a system which could be used to execute further embodiments of methods in accordance with the present invention to execute an estimation of the recondition cost of a target vehicle against the index created in accordance with the method of FIGS. 4 and 5. There is shown a server 1 hosting a database 3 similar to that outlined in FIG. 1, except the server 1 incorporates estimating software 40 instead of modelling software 2. The estimating software 40 could also be the same software as the modelling software 2, simply comprising different components of the single consolidated set of processor instructions and both such approaches are contemplated within the scope of the present invention.

The estimating software 40 will execute the steps of the estimation method to be outlined. Also shown, the server 1 is in network communication with client interface devices—in this case shown as 2 remote PCs 42 which could be used to communicate with the software components of the server 1. The network cloud is also shown in this Figure.

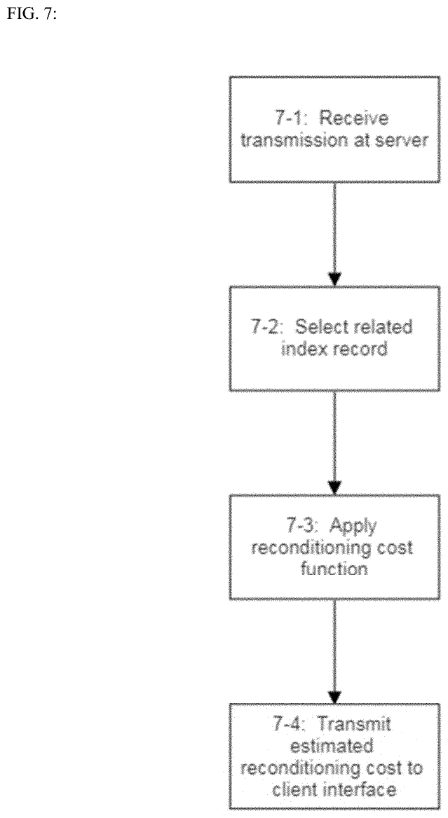

The method of estimation of the recondition cost of a target vehicle in accordance with the method shown in FIG. 7, using a reconditioning cost function 32 established in accordance with the remainder of the methods outlined herein, is reasonably straightforward. The first step of the method of FIG. 7 comprises the receipt at the server of a transmission from a client interface of values of a captured parameter set. The captured parameter set are data related to at least one captured parameter of the target vehicle—for example the captured parameter set might comprise the vehicle manufacturer, the year of manufacture, the model number, and the odometer reading—being four parameters, or some other combination. It will be understood that if the client interface originating the transmission to the server was a client device operably connected to the server allowing for human interface, a data entry form of the light could be used to capture this information. In other embodiments of the method of the present invention, the client interface might comprise a remotely connected computer system such as a business accounting system or the like in an automotive dealership which could automatically transmit the details of captured parameter sets respecting one or more target vehicles to the server 1 in accordance with the present invention for estimation calculations.

On receipt of data corresponding to a captured parameter set up the server 1, as shown in step 7-1, the estimating software component 40 in communication in conjunction with other components of the server 1 and information in the data store 3, could execute the following steps in the method. The estimating software component 40 would first select a related index record 6 from the database 3. The related index record 6 which will be selected would be an index record 6 with an index parameter set 34 corresponding to the parameters captured within the captured parameter set of the transmission received. The client software allowing users to enter the details of captured parameter sets could be programmed to only permit the entry of parameter set values corresponding to available index parameter sets represented in particular index records 6 in the database 3.

Following the identification of a related index record 6, shown at step 7-2, the estimating software component 40 would apply the recondition cost function 32 stored in conjunction with the remainder of the related index record 6 to the details of the transmission being the captured values of at least one vehicle parameter corresponding to the index parameter set 34 of the index record 6 in question. Application of the reconditioning cost function 32 to the received transmitted captured parameter set is shown at 7-3. Application of the recondition cost function 32 would yield a mathematical result, being the estimated recondition cost for the vehicle in question.

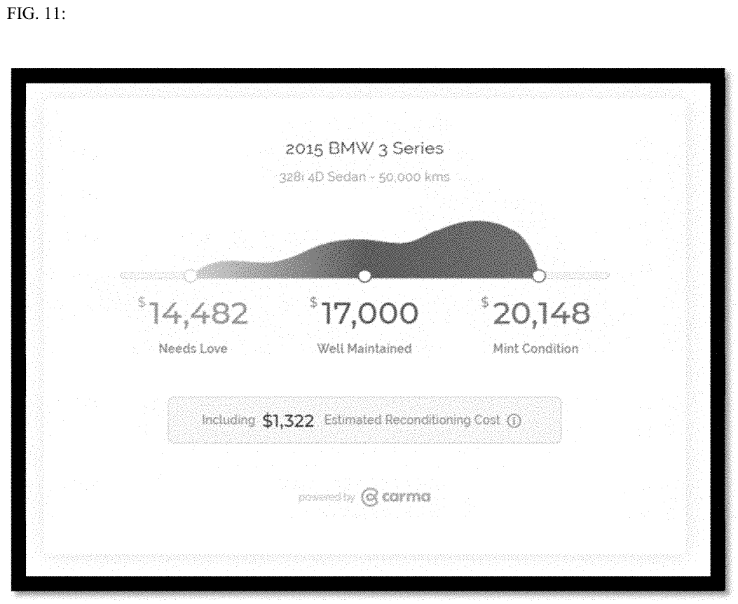

The estimated reconditioning cost would be transmitted, shown at 7-4, back to the client interface for further display or processing. The method demonstrated in this Figure and description effectively outlines the application of a reconditioning cost function 32 which has been determined and stored in accordance with the method of the present invention, based upon historical cost records 5. For example, FIG. 11 depicts a user display as follows might be employed in transmitting and displaying such information to a user.

As outlined above with respect to the establishment of vehicle parameters and vehicle parameter sets for index records 6 or cost records 5, any number of types of vehicle parameters as outlined in further detail elsewhere herein could be used as a captured parameter set corresponding to an index parameter set in accordance with the reconditioning cost estimation method outlined in FIG. 7.

Method Overview—Estimation of Trade-In Value:

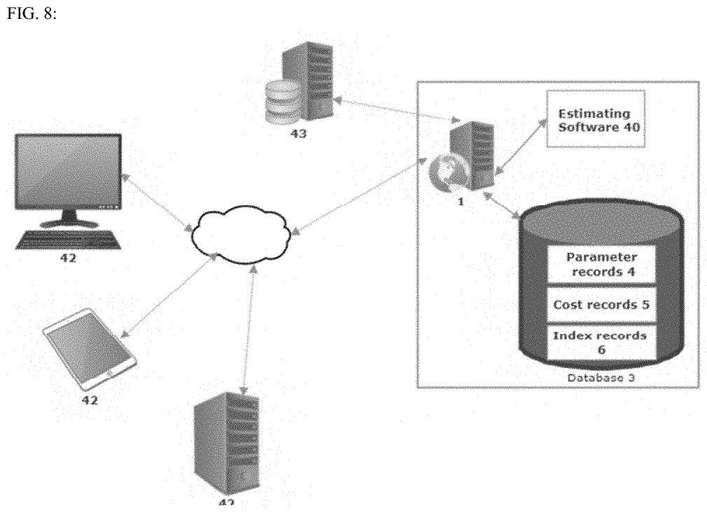

The final aspect of the present invention which it is desired to describe is the method of the calculation of the trade-in value of a target vehicle using a parameter based reconditioning index calculated in accordance with the remainder of the method of the present invention. FIG. 8 demonstrates one example of a schematic of a system which could be used in the execution of this particular type of method. The system shown in FIG. 8 is very similar to the system of FIG. 6 with the exception that a trade-in data source 43 as shown, and in this case is shown as an externally hosted database server with a network connection to the server 1. Also, the client devices 42 shown in this embodiment of the system include a remote computer, remote tablet, as well as a server. This is intended to simply demonstrate the fact that both human and machine transmission of data for the initiation of trade-in valuation transactions is intended to be encompassed within the scope of the present invention. The remainder of the system shown in FIG. 8 is identical to that of FIG. 6.

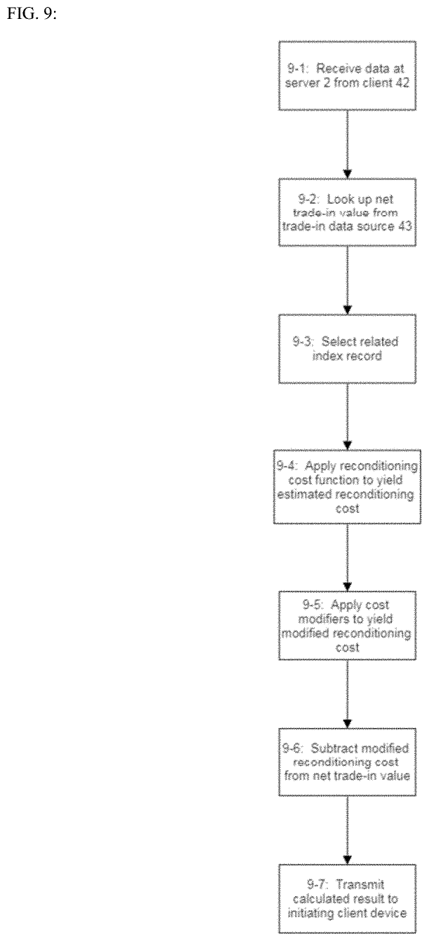

Referring now to FIG. 9 there are shown the steps of a method used to calculate the trade-in value of a particular target vehicle based upon the reconditioning of the target vehicle to a defined standard. From a business level what effectively is required is to calculate the reconditioning cost to return the target vehicle to the defined standard and to subtract that determined cost from the net trade-in value of the vehicle in an ideal condition at the defined standard.

It is contemplated that the system of the present invention used to practice this aspect of the method would incorporate a trade-in data source 43 which could either be an additional data set stored within the database 3, or as shown in FIG. 8 could also be an external data source—in either case, the trade-in data source 43 would provide information related to the net trade-in value of target vehicles of particular types. The vehicle type would be captured from the client interface in addition to the captured parameter set—or the vehicle type might be a part of the captured parameter set in some embodiments—and the vehicle type could then be used to look up the net trade-in value from the trade-in data source 43.

The first step of the method of FIG. 9 is the receipt of a data transmission of the server 2 from the client device 42 corresponding to a captured parameter set and vehicle type. The captured parameter set and the vehicle type of the target vehicle are the information that will be used in the primary steps of the method of the present invention to determine the trade-in value of the vehicle which could be provided by distributorship. As outlined above in some embodiments, the vehicle type might actually be one of the captured parameters within the captured parameter set, or in other cases the vehicle type might be transmitted in a different field, packet or format separate from the captured parameter set—both such approaches are contemplated within the scope of the present invention.

On receipt and parsing of a data packet corresponding to this information at the server 2 in step 9-1, the estimating software component 40 in conjunction with whatever other necessary or related components of the server would look up the net trade-in value of the target vehicle from the trade-in data source 43. This is shown at step 9-2. The trade-in data source 43 shown in FIG. 8 is a cloud connected database server although as also outlined above, the trade-in data source 43 could be a locally hosted or connected data source, or an additional set of records within the database 3. Any such available data source is contemplated within the scope of the present invention.

The estimating software component in my 40 would then select the related index record 6 from the database 3 which corresponded in the contents of its index parameter set 34 to the captured parameter set contents received in the data transmission at the server. The related index record 6 would be used in the next steps of the invention—selection of the related index record comprises step 9-3.

Once the proper related index record 6 has been selected, as shown in step 9-4, the reconditioning cost function 32 of that related index record 6 will be applied to the contents of the captured parameter set received at the server from the client device in step 9-1. The result of the application of that mathematical reconditioning cost function 32 is the estimated reconditioning cost of the target vehicle to the defined standard.

Shown in this particular flowchart at step 9-5, for demonstrative purposes to indicate one means of inclusion of this modification in the method in accordance with the remainder of the method is the application of cost modifiers to the estimated reconditioning cost. The cost modifiers, as outlined in further detail elsewhere herein, could be localizing mathematical formulae or the like used to further transform the standardized estimated reconditioning cost to meet the needs of a particular dealership or customer.

Certain embodiments of the method of the present invention would not include this step, and it will be understood that any number of different types of mathematical modifications from something as simple as a mathematical multiplication factor to a further mathematical function transforming the estimated reconditioning cost in a more complicated way are all contemplated within the scope hereof.

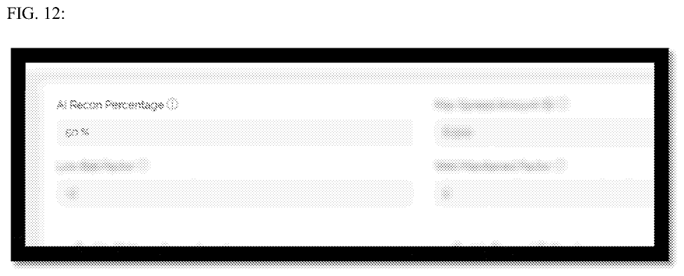

In transforming the reconditioning cost for example dealerships might have the capability of setting one or more parameters that force a percentage of the estimated reconditioning cost by model to be included in the valuation and be shown to the customer, as shown in FIG. 12.

The engine can also take into account other geographic parameters when calculating the estimated reconditioning cost—for instance it could use the minimum wage in each of the Canadian provinces as an indicator of the difference in reconditioning cost.

The next step shown is the subtraction of the modified reconditioning cost from the net trade-in value—this is shown at step 9-6. The result of this subtraction is the calculated trade-in value of the target vehicle the dealer could offer for a vehicle encompassing our accommodating the required cost to reconditioning the vehicle once it was received to the desired defined standard. Finally, shown at 9-7, the calculated result will be transmitted back to the initiating client device for further use.

It will be understood based on the language outlined herein that many different types of mathematical functions which could be applied to captured parameter sets are contemplated for use in accordance with the index records and the remainder of the software and the method of the present invention, to allow for parameter based estimation of the reconditioning cost or trade-in value of target vehicles.

Although the present technology has been described for illustration based on what is considered the most practical and preferred implementations, it is to be understood that such detail is solely for that purpose and that the technology is not limited to the disclosed implementations, but, on the contrary, should cover modifications and equivalent arrangements within the spirit and scope of the appended claims. For example, it is to be understood that the present technology contemplates that, to the extent possible, one or more features of any implementation can be combined with one or more features of any other implementation.

In addition, it will be apparent to those of skill in the art that by routine modification the present invention can be optimized for a wide range of conditions and application. It will also be obvious to those of skill in the art there are various ways and designs with which to produce the apparatus and methods of the present invention. The illustrated embodiments are therefore not intended to limit the invention, but to provide examples of the apparatus and method to enable those of skill in the art to appreciate the inventive concept.

We claim:

1. A computer-implemented method of creating a parameter-based reconditioning index for use in the estimation of the reconditioning cost of target vehicles to a defined standard based upon the historical reconditioning cost of similar vehicles, said method comprising:
a. providing a server comprising:
i. a processor and memory;
ii. a modeling software component for carrying out the steps of the method; and
iii. a reconditioning database comprising:
1. a plurality of parameter records each corresponding to a vehicle parameter in respect of which a value can be captured in respect of a target vehicle and containing details of permissible parameter values;
2. a plurality of cost records each corresponding to a historical reconditioning transaction of a reconditioned vehicle and containing:
a. a parameter value in respect of the reconditioned vehicle for a historical parameter set of at least one vehicle parameter corresponding to a parameter record; and
b. the historical reconditioning cost associated with the transaction; and
3. a plurality of index records each corresponding to a parameter-based index, and containing:
a. details of an index parameter set of at least one vehicle parameter corresponding to a parameter record; and
b. a reconditioning cost function, being a stored mathematical function which correlates the historical reconditioning costs for cost records having vehicle parameters within their historical parameter sets that correspond to the vehicle parameters within the index parameter set and which will, when applied to captured parameter values of a target vehicle corresponding to the index parameter set yield an estimated reconditioning cost for the target vehicle;
b. in an index updating step using the modelling software component to update the reconditioning cost function in respect of a target index record by, on determining the existence of an index update condition:
i. selecting a historical record set of cost records from the reconditioning database having vehicle parameters that correspond to the vehicle parameters within the index parameter set of the target index record;
ii. determining and establishing the reconditioning cost function for the target index record based on the historical record set; and
iii. storing the established reconditioning cost function to the database in association with the target index record;
wherein the reconditioning cost of a target vehicle can be estimated using the reconditioning index by, using a computer and software in operative connection with the reconditioning index:
a) capturing parameter values of at least one vehicle parameter corresponding to a target vehicle, being a captured parameter set;
b) identifying a related index record in the database having vehicle parameters within the index parameter set corresponding to the vehicle parameters in the captured parameter set; and
c) applying the reconditioning cost function associated with the related index record to the parameter values from the captured parameter set to yield the result of the reconditioning cost function being the estimated reconditioning cost of the target vehicle.

2. The method of claim 1, wherein the index updating step is conducted offline from the use of the reconditioning index in the estimation of reconditioning cost of target vehicles.

3. The method of claim 1, wherein the reconditioning cost function associated with a index record is a mathematical function of a type selected from the list of:
a. Linear Regression;
b. Naive Bayes Classification and Regression;
c. Ordinary Least Squares Regression;
d. Neural Networks;
e. Logistic Regression;
f. K-means Clustering;
g. Apriori Association Rule Learning;
h. Singular Value Decomposition;
i. Human Plausible Reasoning; or
j. Rough Sets.

4. The method of claim 1, wherein the at least one vehicle parameter of an index parameter set is selected from the group of:
a. vehicle type;
b. vehicle manufacturer;
c. vehicle model;
d. vehicle model year;
e. vehicle odometer reading;
f. vehicle configuration options;
g. vehicle trim options;
h. vehicle identification number (VIN);
i. total reconditioning cost;
j. start and end date and time of reconditioning; and
k. estimated reconditioning cost for the vehicle before the reconditioning was started.

5. The method of claim 1, wherein the cost records correspond to vehicles having been reconditioned by a plurality of reconditioning outlets.

6. The method of claim 1, wherein a reconditioning cost function accommodates the application of at least one cost modifier to the estimated reconditioning cost.

7. The method of claim 6, wherein the cost modifiers are selected from the list of:
a. user-specific cost modifiers;
b. geographic cost modifiers;
c. sub-total labour cost;
d. sub-total parts cost;
e. estimated market value of the vehicle before reconditioning was started;
f. accident and repair history modifiers; and
g. average labour cost at the time or location of reconditioning to be conducted.

8. The method of claim 1, wherein the index update condition is selected from the list of:
a. a manually triggered index update condition indicated by a client interface in communication with the server;
b. a programmatically triggered index update condition indicated by receipt of a triggering indication for another computer in network communication with the server;
c. a preprogrammed time-based frequency trigger; or
d. the addition or modification of cost records to the database.

9. The method of claim 1, wherein an index update condition pertains to all of the index records in the database.

10. The method of claim 1, wherein an index update condition pertains to less than all of the index records in the database.

11. The method of claim 1, wherein a reconditioning cost function for the estimation of an reconditioning cost for a target vehicle where the parameter values within the captured parameter set are outside the range of historical parameter values used to generate the function.

12. A computer-implemented method of estimating the cost of reconditioning a target vehicle to a defined standard using a parameter-based reconditioning index, said method comprising:
a. providing a server comprising:
i. a processor and memory;
ii. an estimating software component for carrying out the steps of the method; and
iii. a reconditioning database comprising:
1. a plurality of parameter records each corresponding to a vehicle parameter in respect of which a value can be captured in respect of a target vehicle and containing details of permissible parameter values;
2. a plurality of cost records each corresponding to a historical reconditioning transaction of a reconditioned vehicle and containing:
a. a parameter value in respect of the reconditioned vehicle for a historical parameter set of at least one vehicle parameter corresponding to a parameter record; and
b. the historical reconditioning cost associated with the transaction; and
3. a plurality of index records each corresponding to a parameter-based index, and containing:
a. details of an index parameter set of at least one vehicle parameter corresponding to a parameter record; and
b. a reconditioning cost function, being a stored mathematical function which correlates the historical reconditioning costs with parameter values of the related reconditioned vehicle for cost records having vehicle parameters within their historical parameter sets that correspond to the vehicle parameters within the index parameter set and which will, when applied to current parameter values of a target vehicle corresponding to the index parameter set, yield an estimated reconditioning cost for the target vehicle predicted by historical reconditioning costs of similar reconditioned vehicles;
b. on receipt of data corresponding to a captured parameter set of at least one vehicle parameter value of the target vehicle at the server from a client interface in communication with the server, using the estimating software component:
i. identifying a related index record having vehicle parameters within the index parameter set that correspond to the vehicle parameters within captured parameter set;
i. applying the reconditioning cost function associated with the related index record to the parameter values from the captured parameter set to yield the estimated reconditioning cost of the target vehicle; and
ii. transmitting the estimated reconditioning cost of the target vehicle to the client interface for display or further processing.

13. The method of claim 12, wherein the at least one vehicle parameter of an index parameter set is selected from the group of:
a. vehicle type;
b. vehicle manufacturer;
c. vehicle model;
d. vehicle model year;
e. vehicle odometer reading;
f. vehicle configuration options;
g. vehicle trim options;
h. vehicle identification number (VIN);
i. total reconditioning cost;
j. start and end date and time of reconditioning; and
k. estimated reconditioning cost for the vehicle before the reconditioning was started.

14. The method of claim 12, wherein the reconditioning cost function of the related index record further comprises the application of at least one cost modifier to the estimated reconditioning cost.

15. The method of claim 14, wherein the local cost modifiers are selected from the list of:
a. user-specific cost modifiers;
b. geographic cost modifiers;
c. sub-total labour cost;
d. sub-total parts cost;
e. estimated market value of the vehicle before reconditioning was started;
f. accident and repair history modifiers; and
g. average labour cost at the time or location of reconditioning to be conducted.

16. The method of claim 12, wherein the reconditioning cost function associated with the related target index record permits for the association of an estimated reconditioning cost for a target vehicle where the values within the captured parameter set are outside the range of historical parameter values used to generate the function.

17. The method of claim 12, wherein the server is a web server with a network interface, and the client interface comprises a client device in communication with the server.

18. The method of claim 12, wherein the reconditioning cost function associated with a index record is a mathematical function of a type selected from the list of:
a. Linear Regression;
b. Naive Bayes Classification and Regression;
c. Ordinary Least Squares Regression;
d. Neural Networks;
e. Logistic Regression;
f. K-means Clustering;
g. Apriori Association Rule Learning;
h. Singular Value Decomposition;
i. Human Plausible Reasoning; or
j. Rough Sets.

19. A computer-implemented method of estimating the trade-in value of a target vehicle using a parameter-based reconditioning index, said method comprising:
a, providing a server comprising:
i. a processor and memory;
ii. an estimating software component for carrying out the steps of the method;
iii. an operative connection to a reconditioning database comprising:
1. a plurality of parameter records each corresponding to a vehicle parameter in respect of which a value can be captured in respect of a target vehicle and containing details of permissible parameter values;
2. a plurality of cost records each corresponding to a historical reconditioning transaction of a reconditioned vehicle and containing:
c. a parameter value in respect of the reconditioned vehicle for a historical parameter set of at least one vehicle parameter corresponding to a parameter record; and
d. the historical reconditioning cost associated with the transaction; and
3. a plurality of index records each corresponding to a parameter-based index, and containing:
e. details of an index parameter set of at least one vehicle parameter corresponding to a parameter record; and
f. a reconditioning cost function, being a stored mathematical function which correlates the historical reconditioning costs with parameter values of the related reconditioned vehicle for cost records having vehicle parameters within their historical parameter sets that correspond to the vehicle parameters within the index parameter set and which will, when applied to current parameter values of a target vehicle corresponding to the index parameter set, yield an estimated reconditioning cost for the target vehicle predicted by historical reconditioning costs of similar reconditioned vehicles; and
iv. an operative connection to a trade-in data source comprising a plurality of trade-in records each corresponding to a net trade-in value for a particular type of vehicle;
c. on initiation of an estimation transaction in respect of a target vehicle:
i. in a data capture step, receiving data at the server from a client device corresponding to:
1. parameter values of at least one vehicle parameter of the target vehicle, being a captured parameter set; and
2. the vehicle type of the target vehicle;
ii. using the vehicle type of the target vehicle, determining the net trade-in value for the target vehicle from the trade-in data source;
iii identifying a related index record having vehicle parameters within the index parameter set that correspond to the vehicle parameters within captured parameter set;
iv. applying the reconditioning cost function associated with the related index record to the parameter values from the captured parameter set to yield the reconditioning cost function being the estimated reconditioning cost of the target vehicle;
v. calculating the trade-in value of the target vehicle by subtracting the estimated reconditioning cost from the net trade-in value of the target vehicle; and
i. transmitting the trade-in value of the target vehicle to the initiating client device for display or further processing.

20. The method of claim 19, wherein the at least one vehicle parameter of an index parameter set is selected from the group of:
a. vehicle type;
b. vehicle manufacturer;
c. vehicle model;
d. vehicle model year;
e. vehicle odometer reading;
f. vehicle configuration options;
g. vehicle trim options;
h. vehicle identification number (VIN);
i. total reconditioning cost;
j. start and end date and time of reconditioning; and
k. estimated reconditioning cost for the vehicle before the reconditioning was started.

21. The method of claim 19, wherein the estimation of the reconditioning cost of the vehicle further comprises the application of at least one cost modifier to the estimated reconditioning cost.

22. The method of claim 21, wherein the cost modifiers are selected from the list of:
a. user-specific cost modifiers;
b. geographic cost modifiers;
c. sub-total labour cost;
d. sub-total parts cost;
e. estimated market value of the vehicle before reconditioning was started;
f. accident and repair history modifiers; and
g. average labour cost at the time or location of reconditioning to be conducted.

23. The method of claim 19 wherein the server is a web server with a network interface, and the client interface comprises a client device in communication with the server.
